(19) United States
(12) Patent Application Publication
(10) Pub. No.: US 2003/0163830 A1
(43) Pub. Date: Aug. 28, 2003

(54) Method for automatically searching cable TV band

(76) Inventor: Ho Jun Nam, Seoul (KR)

Correspondence Address: BIRCH STEWART KOLASCH & BIRCH, PO BOX 747, FALLS CHURCH, VA, 22040-0747, US

(21) Appl. No.: 10/340,686

(22) Filed: Jan. 13, 2003

(30) Foreign Application Priority Data
Feb. 23, 2002 (KR) 2002-0009763

(51) Int. Cl. H04N 7/173; H04N 7/16; H04N 5/50

(52) U.S. Cl. 725/120; 725/130; 725/150; 348/731; 348/732; 725/117; 725/147

(57) ABSTRACT

A method for automatically searching a cable TV band is disclosed to effectively perform a cable TV band searching in a TV or a set-top box which is available for receiving a ground wave broadcast signal. The method includes the steps of: detecting a cable TV band for a channel of a VHF frequency band; and detecting a cable TV band for a channel of a frequency band a ground TV does not use in order to confirm whether the detected cable TV band is accurate.

### BACKGROUND OF THE INVENTION

1. Field of the Invention

The present invention relates to a method for searching a cable TV band and, more particularly, to a method for automatically searching a cable TV band to effectively perform a cable TV band searching in a TV or a set-top box which is available for receiving a ground wave broadcast signal.

2. Description of the Background Art

Currently, cable TV broadcast stations perform a must-carry to provide a ground wave broadcast signal as well as a cable broadcast signal to users who have subscribed for a cable TV.

That is, as shown in FIG. 1, a cable broadcast station converts a ground wave analog TV broadcast signal (NTSC) or a ground wave digital TV broadcast signal (8VSB) signal into a frequency of a cable band by means of a frequency converter 100, combines a broadcast signal made by the cable broadcast station itself and the ground wave broadcast signal which has been converted into the frequency of cable band by means of a coupler 110, and transmits it to a cable TV receiving subscriber 120.

The cable band used in the cable TV broadcast includes a ‘STD’ band, a ‘HRC’ band, and an ‘IRC’ band.

Each cable TV broadcast station can select one of three cable bands, and at this time, a TV set of a cable TV subscriber receiving a cable broadcasting should be able to determine what band the cable broadcast station has selected.

That is, the TV set of the cable TV subscriber determines which one of the ‘STD’ band, ‘HRC’ band and an ‘IRC’ band the TV broadcast station has selected by a frequency of a received broadcast signal.

FIG. 3 illustrates a normal case that a cable TV subscriber receives a cable broadcast signal.

As shown in FIG. 3, if a cable broadcast subscriber is moved out or if the subscriber cancels receiving of a cable broadcast, a cable TV broadcast station removes a cable connected to the subscriber to be used for receiving a cable broadcast and terminates the cable so that a noise signal such as a ground wave TV signal may not affect a cable broadcast signal.

FIG. 4 illustrates an example of receiving of a cable broadcast with a TV signal interference.

With reference to FIG. 4, in the case of FIG. 3 that a cable broadcast subscriber has been moved out or the subscriber has canceled receiving of a cable broadcast, if a cable for receiving of a cable broadcast has been removed but not terminated and left as it is, the non-terminated cable for receiving a cable broadcast operates as an antenna. Then, a noise component such as the ground wave TV signal intrudes into the cable broadcast receiving cable to cause a ghost in receiving a cable broadcast.

Especially, the noise component has much influence on a cable band searching algorithm performed to store a cable broadcast channel.

That is, as shown in FIG. 2, for a channel 2 or a channel 13, a center frequency of the ground wave TV and a center frequency of the STD band of a cable TV are the same with each other, so that it is difficult to determine whether the STD band has been determined by a cable TV signal or by an interference component of a ground wave TV signal in a cable band searching algorithm.

Therefore, in such a case that the ground wave TV signal is contained as the interference component in the cable TV signal, a cable TV band searching algorithm in accordance with the conventional art can not perform an accurate cable TV band searching.

### SUMMARY OF THE INVENTION

Therefore, an object of the present invention is to provide a method for searching a cable TV band that is capable of searching a cable TV band by using a cable TV channel of a frequency band a ground wave TV broadcast does not use.

To achieve these and other advantages and in accordance with the purpose of the present invention, as embodied and broadly described herein, there is provided a method for searching a cable TV band including the steps of: detecting a cable TV band for a channel of a VHF frequency band; and detecting a cable TV band for a channel of a frequency band a ground TV does not use in order to confirm whether the detected cable TV band is accurate.

To achieve the above objects there is also provided a method for searching a cable TV band including the steps of: tuning from a channel 14 to a channel 11 of a VHF frequency band and detecting synchronization of a tuned channel; judging a cable TV band of the synchronization-detected channel; judging whether the synchronization-detected channel is an STD band and IRC band discriminated channel (the STD band and IRC band discriminated channel is a channel 5 or a channel 6); increasing an IRC band counter value, an IRC band counter value and an HRC band counter value according to the judged cable TV band if the synchronization-detected channel is not the STD band and IRC band discriminated channel; judging whether a cable band has been judged for the STD band and the IFC band discriminated channel if one of the band counter values is above a pre-set threshold value; and performing a cable band judging for the STD band and IRC band discriminated channel if the cable band has not been judged yet for the STD band and IFC band discriminated channel.

To achieve the above objects there is also provided a method for searching a cable TV band including the steps of: detecting a synchronization while sequentially tuning channels from 14 to 64; judging a cable TV band for a synchronization-detected channel when a synchronization is detected in one of the channels; and determining an STD band as a final cable TV band if the judged cable TV band is the STD band, or otherwise determining an HRC band as a final cable TV band if the judged cable TV band is the HRC band.

To achieve the above objects there is also provided a method for searching a cable TV band including the steps of: detecting a synchronization while sequentially tuning channels from 95 to 99 if no synchronization is detected in channels from 14 to 64; judging a cable TV band of a synchronization-detected channel if synchronization is detected in one of the channels; and determining an STD band as a final cable TV band if the judged cable TV band is the STD band, or otherwise determining an HRC band as a final cable TV band if the judged cable TV band is the HRC band.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates one example that a cable TV broadcast station transmits a cable TV broadcast signal including a ground wave TV signal;

FIG. 2 is a table showing center frequencies of ground wave TV channel and a cable TV channel;

FIG. 3 illustrates a case in which a cable TV subscriber receives a cable broadcast signal;

FIG. 4 illustrates an example of receiving a cable broadcast with an interference of a ground wave TV signal;

FIG. 5 is a flow chart of searching a cable TV band in channels from 1 to 13 in accordance with the present invention;

FIG. 6 is a flow chart of performing a routine ‘A’ in accordance with the present invention;

FIG. 7 is a flow chart of performing a routine ‘C’ in accordance with the present invention;

FIG. 8 is a flow chart of performing a routine ‘B’ in accordance with the present invention;

FIG. 9 is a flow chart of performing a routine ‘D’ in accordance with the present invention; and

FIG. 10 is a flow chart of performing a routine ‘E’ in accordance with the present invention.

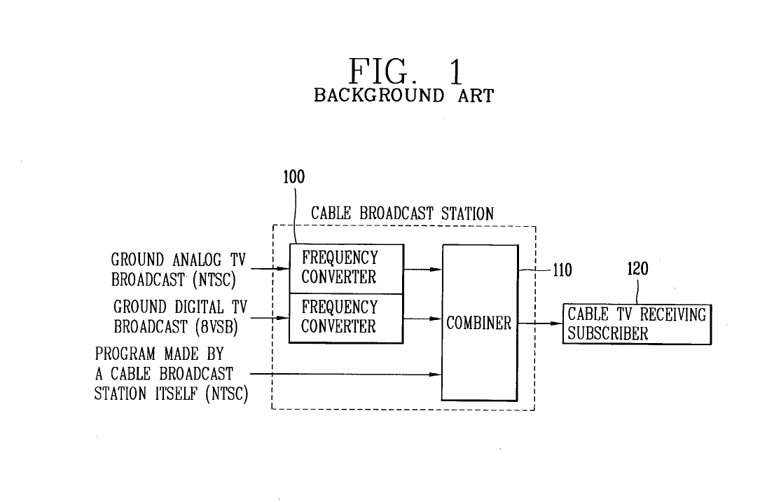

### DETAILED DESCRIPTION OF THE PREFERRED EMBODIMENTS

Reference will now be made in detail to the preferred embodiments of the present invention, examples of which are illustrated in the accompanying drawings.

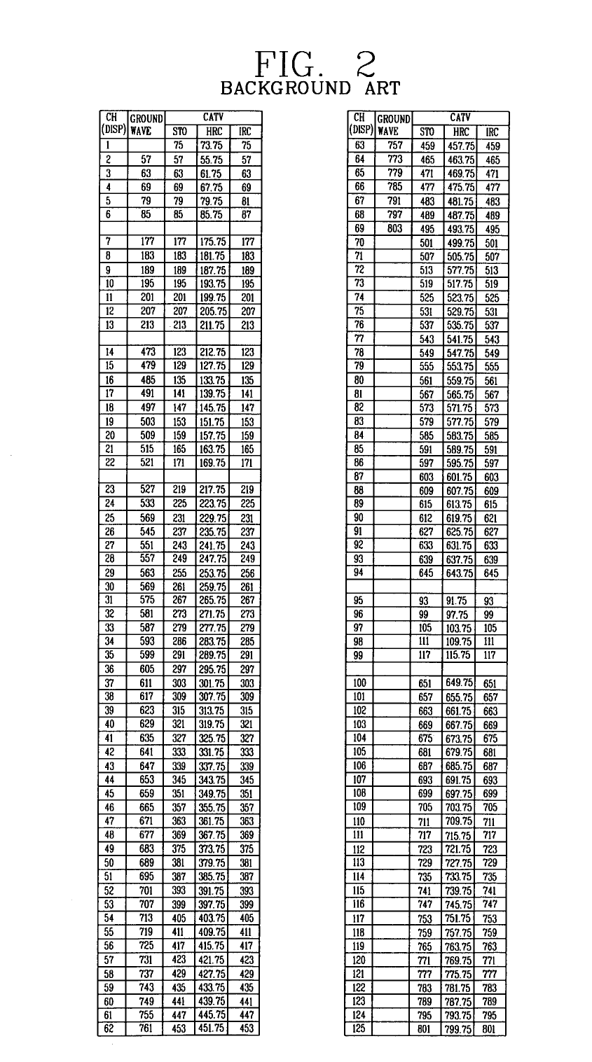

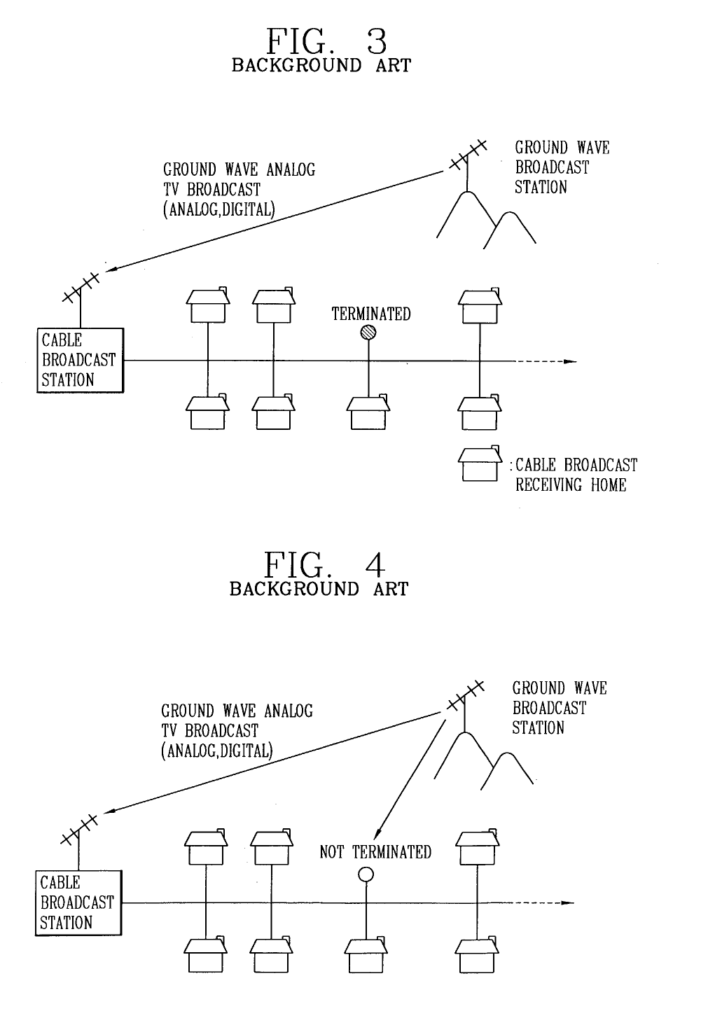

FIG. 2 is a table showing center frequencies of ground wave TV channel and a cable TV channel.

The frequency table of FIG. 2 has the following characteristics.

First, the ground wave TV broadcast includes channels of 2 to 69 while a cable TV broadcast includes channels of 1 to 125.

Second, the same frequency band of a channel is used for the cable TV broadcast and the ground wave TV broadcast.

Third, the cable TV broadcast has three cable TV bands (STD, HRC, IRC), and the STD band and the IRC band have the same center frequency except for the channels 5 and 6.

Fourth, the HRC band among the cable TV bands has a frequency of below 1.25 MHz compared to the STD band in every channel except for the channels 5 and 6.

Fifth, the center frequency of the STD band of the cable TV broadcast and that of the ground wave TV broadcast are the same in channels of 2 to 13.

Sixth, the center frequency of the IRC band of the cable TV broadcast and that of the ground wave TV broadcast are the same in every channel except for channels 5 and 6.

Seventh, as for the STD band of the cable TV broadcast, there is a ground wave TV broadcast channel above 2 MHz in channels of 65 to 94 and channels of 100 to 125.

Lastly, frequency band used in channels of 14 to 64 and channels of 95 to 99 of the STD band is not used for the ground wave TV broadcast.

A method for searching a cable TV band using the frequency characteristics of a ground wave TV broadcast and a cable TV broadcast in accordance with the present invention will now be described with reference to the accompanying drawings.

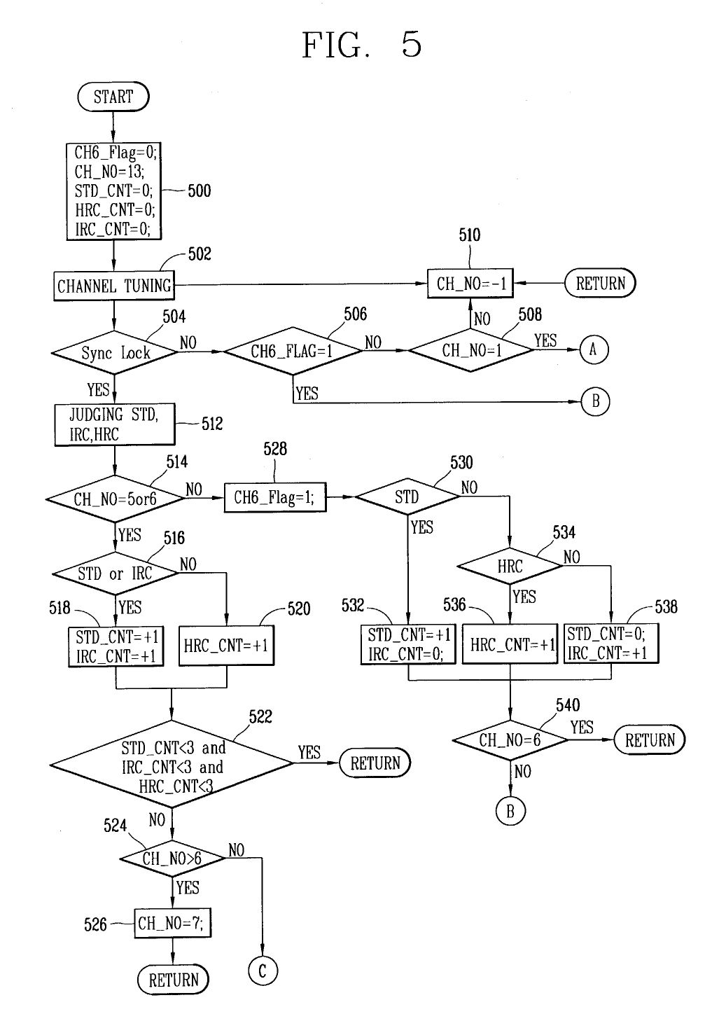

FIG. 5 is a flow chart of searching a cable TV band in channels from 1 to 13 in accordance with the present invention.

First, variables of ‘CH_NO’, ‘STD_CNT’, ‘HRC_CNT’, ‘IRC_CNT’ and ‘CH6_Flag’ for searching a cable TV band are initialized (step S500).

That is, for the purpose of searching a cable TV band of channels 1 to 13 having a center frequency of a VHF frequency band, ‘CH_NO’ is set to be 13 and ‘STD_CNT’, ‘HRC_CNT’ and ‘IRC_CNT’ and ‘CH6_Flag’ are set to be ‘0’.

‘CH_NO’ is a channel variable, ‘STD_CNT’, ‘HRC_CNT’ and ‘IRC_CNT’ are counter variables of STD band, HRC band and IRC band of a searched cable TV, and ‘CH6_Flag’ is a variable indicating existence or non-existence of a signal in channel 5 or 6.

Subsequently, a selected channel is tuned (step S502), and it is judged whether a synchronization is detected in the tuned channel (step S504). Detection of synchronization in the tuned channel signifies that there is a TV signal in the tuned channel.

If no synchronization is detected in the tuned channel, it is judged whether ‘CH6_Flag’ is ‘1’ (step S506). If, however, ‘CH6_Flag’ is not ‘1’, it is judged whether ‘CH_NO’ is ‘1’ (step S508).

In the step S508, if ‘CH_NO’ is not ‘1’, ‘CH_NO’ is reduced by ‘1’ (step S510) and tuning is performed again, in order to proceed with the step of judging whether a TV signal is detected in the next channel. If the tuned channel is the channel 1 (CH_NO=1), it proceeds with a routine ‘A’ because there is no channel to be tuned.

Meanwhile, in the step S506, if ‘CH6_Flag’ is ‘1’, it proceeds with the routine ‘A’ to search a cable band for a TV signal existing in channel 5 and 6, rather than tuning and detecting synchronization for channels of 4 to 1, which are below channel 5.

If ‘CH6_Flag’ is ‘1’, it means that there is a TV signal in channel 5 or 6.

If a synchronization is detected in the tuned channel in the step S502, it is judged whether a cable band of the synchronization-detected channel is the STD band, the IRC band or the HRC band (step S512).

The algorithm for judging a cable TV band for the synchronization-detected channel is not main concern of the present invention, descriptions of which are thus omitted.

Subsequently, it is judged whether the channel variable ‘CH_NO’ is 5 or 6 in order to check whether the cable TV band-judged channel is channel 5 or 6 (step S514).

If ‘CH_NO’ is neither 5 or 6, it is judged whether the cable TV band judged in the step S512 is the STD band (or the IRC band). If the judged cable band is the STD band (or the IRC band), the values of ‘STC_CNT’ and ‘IRC_CNT’, counter variables of the STD band and the IRC band, are increased by ‘1’, respectively (step 'S518). The reason of increasing both values of ‘STC_CNT’ and ‘IRC_CNT’ is because the center frequencies of the STD band and the IRC band of other channels than channels 5 and 6 among channels 13 to 1 are the same with each other.

Meanwhile, if, however, the cable TV band is not the STD band (nor IRC band), the value of ‘HRC_CNT’, a counter variable of the HRC band, is increased by ‘1’ (step S520).

And then, it is judged whether all of the counter variable values (STD_CNT, IRC_CNT and HRC_CNT) are less than the pre-set threshold value ‘3’ according to the tuning result for the channels except for the channel 5 and 6 (step S522). If all of the counter variable values are less than ‘3’, it proceeds with a ‘return routine’ to tune the next channel.

The pre-set threshold value ‘3’ is a reference value indicating whether 3 or more channels are judged to have the same cable TV band according to a cable band detecting result, which can be varied.

F one of the counter variables STD_CNT, IRC_CNT and HRC_CNT is above ‘3’ in the step S522, it is judged whether a cable band has been also detected for channels 6 and 5 (step S524). If the channel number ‘CH_NO’ is greater than ‘7’, the ‘CH_NO’ is set to be ‘7’ (step S526) and it proceeds with the ‘return routine’ to tune the next channel, that is, channels 6 to 1.

The reason for setting ‘CH_NO’ as ‘7’ is to reduce a cable band detecting time by omitting a process of detecting a cable band according to a channel tuning for channels 8 and 7 in case that, for example, a cable band is detected in channels up to 9.

If ‘CH_NO’ is 5 or 6 in the step S514, ‘CH_Flag’ is set to be ‘1’ (step S528). And then, if a cable TV band of a TV signal existing in channel 5 or 6 is judged to be the STD band (step S530), the counter variable value ‘STD_CNT’ is increased by ‘1’ and at the same time the value ‘IRC_CNT’ is set to be ‘0’ (step S532).

If the cable TV band of the TV signal existing in channel 5 or 6 is judged to be HRC band (step S534), the counter variable vale ‘HRC_CNT’ is increased by ‘1’ (step S536).

The reason for increasing only the counter variable value ‘HRC_CNT’ by ‘1’ while leaving the counter variable values ‘STD_CNT’ and ‘IRC_CNT’ as it is s to search an accurate cable band even with an external noise influence such as the ground wave TV signal.

If the cable TV band of the TV signal existing in channel 5 or 6 is judged to be the IRC band, the counter variable value ‘IRC_CNT’ is increased by ‘1’ and the value ‘STD_CNT’ is set to be ‘1’ (step S538).

At this time, channels 5 and 6 have different center frequencies according to a cable band, the STD band, the IRC band and the HRC band can be accurately discriminated.

Subsequently, it is judged whether the channel number ‘CH_NO’ is ‘6’ (step S540). If the channel number is ‘6’, it proceeds with the ‘return loop’ to performing a tuning to judge a cable TV band for the channel 5. If the channel number ‘5’, it proceeds with a routine ‘B’.

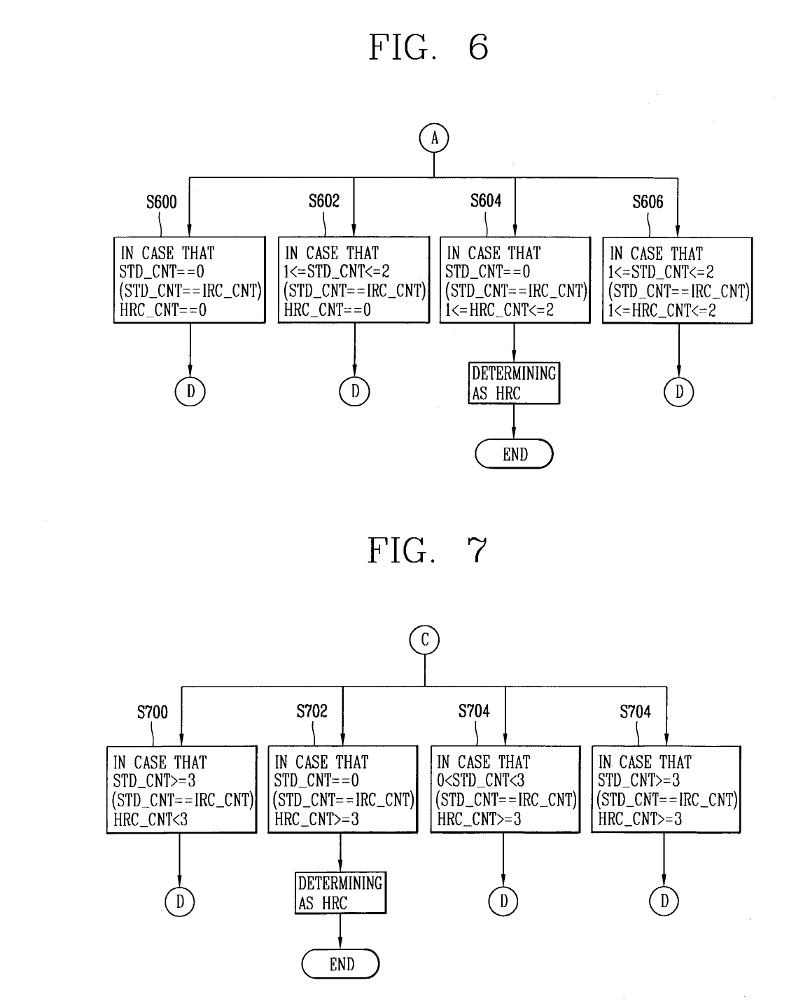

FIG. 6 is a flow chart of performing a routine ‘A’ in accordance with the present invention.

The routine ‘A’ is performed in case that there is no TV signal in channel 5 or 6 and none of three counter variables is above the pre-set threshold value ‘3’ according to determining a cable TV band for other channels than the channel 5 and 6.

First, if no synchronization is detected in channels 13 to 1, it is impossible to judge a cable TV band. Then, the cable TV band is set to be STD, a default value, or a routine ‘D’ is performed to detect an accurate cable TV band (step S600).

If the cable TV band is judged to be STD band in one or more but less than 2 channels among channels 13 to 1 except for the channels 5 and 6, since it can be erroneously judged as the STD band due to the interference of the ground wave TV signal, the routine ‘D’ is performed to detect an accurate cable TV band (step S602).

If the cable TV band is judged to be STD band in one or more but less than 2 channels among channels 13 to 1 except for the channels 5 and 6, the final cable TV band is determined as the HRC band and the cable TV band searching routine is terminated (step S605).

At this time, since the cable TV band is judged to be only the STD band owing to the interference of the ground wave TV signal, if the cable TV band is judged to be the HRC band, the cable TV band searching routine is terminated.

If the there are one or more but less than two channels in which a cable channel band is judged to be the HRC band among channels 13 to 1 except for channels 5 and 6 and there are one or more but less than 2 channels in which a cable TV band is judged to be the STD band, the routine ‘D’ is performed to detect an accurate cable TV band (step S606).

Such a case happens when a cable broadcast station uses the HRC band and there is an interference by a ground wave TV signal. In this case, the cable TV band may be determined to be the HRC band and the cable TV band searching routine is terminated, but the routine ‘D’ is preferably performed to detect an accurate cable TV band.

FIG. 7 is a flow chart of performing a routine ‘C’ in accordance with the present invention.

A routine ‘C’ is performed if there is no signal in channels 5 and 6 and one of counter variable values is above ‘3’ according to judging of the cable TV band in channels 13 to 1 except for channels 5 and 6.

First, if the counter variable value ‘STD_CNT’ is above ‘3’ and ‘HRC_CNT’ is smaller than ‘3’, a cable TV band can be determined as the STD band due to the interference of the ground wave TV signal. Thus, for the purpose of detecting an accurate cable TV band, the routine ‘D’ is performed (step S700).

If only the counter variable value ‘HRC_CNT’ is above ‘3’ and other counter variable values are ‘0’, since a cable TV band can not be judged to be the HRC band due to the interference of the ground wave TV signal, the cable TV band is determined as HRC band and the cable TV band detecting routine is terminated (step S702).

If the counter variable value ‘HRC_CNT’ is above ‘3’ and the value ‘STD_CNT’ is smaller than ‘3’, there is a high possibility that a cable TV band is the HRC band. In this respect, however, since there is a channel which has been judged to be the STD band, the routine ‘D’ is performed to detect an accurate cable TV band (step S704).

If the counter variable values ‘HRC_CNT’ and ‘STD_CNT’ are all above ‘3’, it is difficult to judge whether a cable TV band is the HRC band or the STD band. Thus, the routine ‘D’ is performed to detect an accurate cable TV band (step S706).

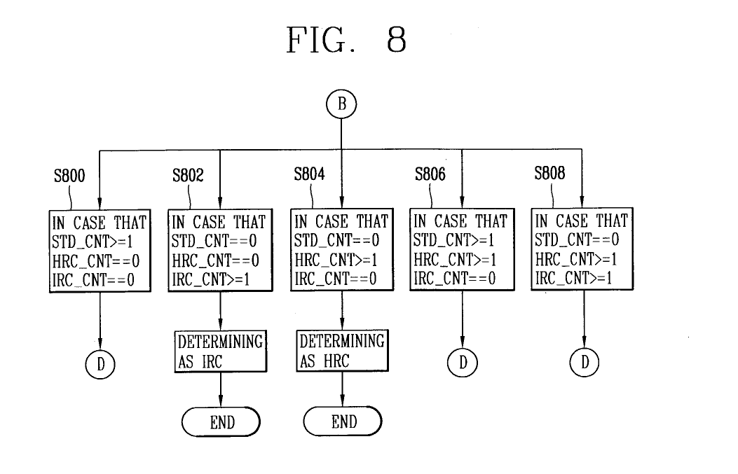

FIG. 8 is a flow chart of performing a routine ‘B’ in accordance with the present invention.

The routine ‘B’ is performed when there is a TV signal in channel 5 or 6.

First, if only the counter variable ‘SNT_CNT’ is above ‘1’ in channel 5 or 6 while the other counter variable values are ‘0’, a cable TV band can be the STD band, which, however, can be erroneously judged due to the interference of the ground wave TV signal. Thus, for the purpose of detecting an accurate cable TV band, the routine ‘D’ is performed (step S800).

If only the counter variable value ‘IRC_CNT’ is above ‘1’ in the channel 5 or 6 while the other counter variable values are ‘0’, the cable TV band is determined to be the IRC band and then the cable TV band detecting routine is terminated (step S802).

If only the counter variable value ‘HRC_CNT’ is above ‘1’ in the channel 5 or 6 while the other counter variable values are ‘0’, the cable TV band is determined to be the HRC band and then the cable TV band detecting routine is terminated (step S804).

If the counter variable values ‘STD_CNT’ and ‘IRC_CNT’ are above ‘1’ while the IRC_CNT is ‘0’, the routine ‘D’ is performed to detect an accurate cable TV band (step S806).

If the counter variable values ‘HRC_CNT’ and ‘IRC_CNT’ are above ‘1’ while the STD_CNT is ‘0’, the routine ‘D’ is performed to detect an accurate cable TV band (step S808).

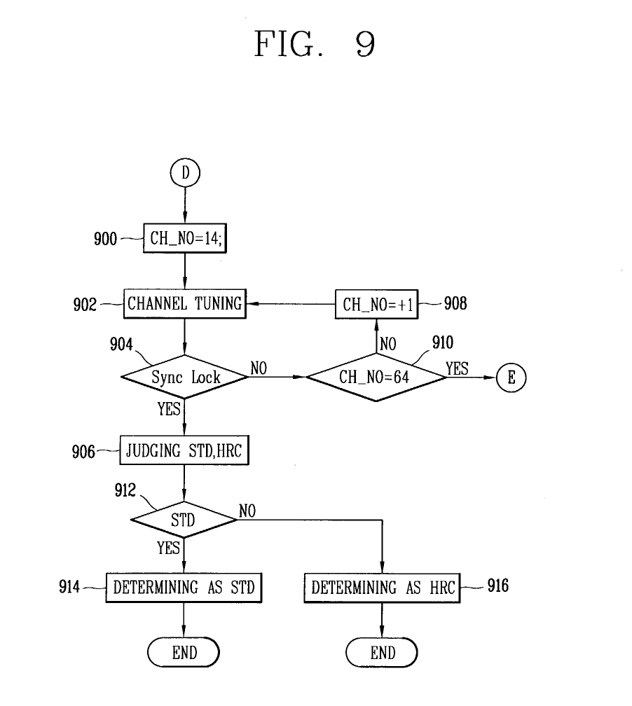

FIG. 9 is a flow chart of performing a routine ‘D’ in accordance with the present invention.

The routine ‘D’ is performed when an accurate cable TV band can not be judged by the routines ‘A’, ‘B’ and ‘C’, which is a routine of channels having a center frequency that is not used for a ground wave TV, that is, channels 14 to 64.

The channels 14 to 64 have a frequency distanced by more than a minimum 6 MHz from a frequency of channels used for the ground wave TV.

First, channels are tuned in turn from 14 to 64. If a synchronization is detected even in one channel, a cable TV band is judged for the synchronization-detected channel and the judged cable TV band is determined to be the final cable TV band. And then, the cable TV band searching routine is terminated.

That is, after ‘CH_NO’ is set to be ‘14’ to search the cable TV band from the channel 14 (step S900), a channel tuning is performed on the channel 14 (step S902). When a synchronization is detected in the tuned channel 14 (step S904), a cable TV band is judged for the channel 14 (step S906).

If, however, no synchronization is detected in the tuned channel 14, the channel number ‘CH_NO’ is reduced ‘1’ by ‘1’ (step S908) in order to repeatedly perform the channel tuning and synchronization detecting process up to the channel 64 until a synchronization is detected in the tuned channel (step S910).

If the cable TV band judged in the step S906 is STD band (step S912), a cable TV band is finally determined to be STD band (step S914). If the cable TV band judged in the step S906 is not the STD band, a cable TV band is determined to be the HRC band (step S916) and the entire cable TV band judging routine is terminated.

The channel tuning and synchronization detecting are repeatedly performed on the channels 14 to 64, and if a synchronization is detected in even one channel, a cable TV band searching process is performed on the synchronization-detected channel. If, however, no synchronization is detected in channels 14 to 64, a routine ‘E’ is performed.

As illustrated in FIG. 2, as for the channels 14 to 64, since the center frequencies of the STD band and the IRC band are the same with each other, the STD band and the IRC band are not discriminated, whereas the STD band (or the IRC band) and the HRC band can be judged.

Therefore, in the case that a cable TV band is judged to be the STD band in the routine ‘D’, if no synchronization is detected by using the STD band in the digital cable channels 5 and 6 when a channel map is constructed on the digital cable channels while scanning the digital cable channel with the STD band, a channel tuning must be performed by using the IRC band.

The reason is that if a cable broadcast station practically uses the IRC band but there is no signal in analog cable channels 5 and 6, a cable TV band is judged to be the STD band in a cable TV band searching algorithm, and in such a case, a case where there is a digital cable signal as a center frequency of the IRC band in the channels 5 and 6 needs to be coped with.

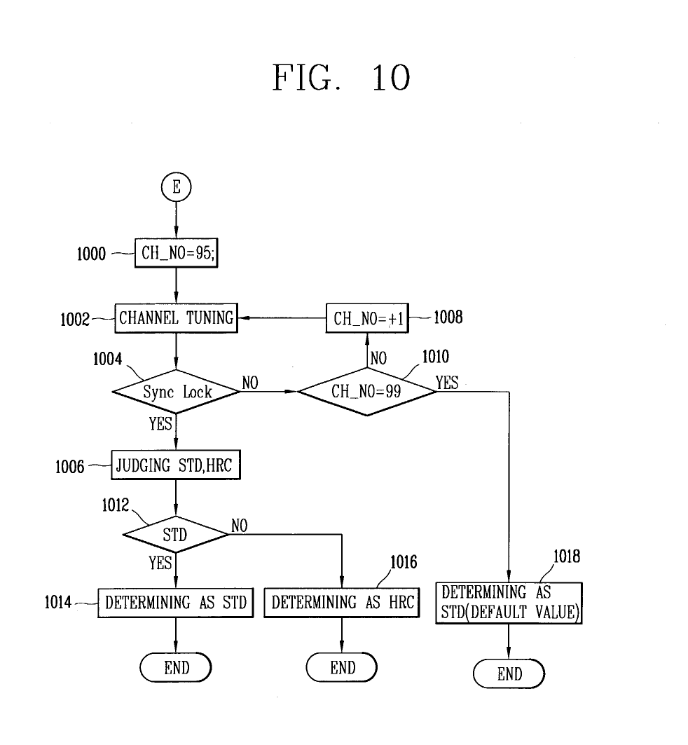

FIG. 10 is a flow chart of performing a routine ‘E’ in accordance with the present invention.

The routine ‘E’ is performed when an accurate cable TV band can not be judged in the routine ‘D’ of FIG. 9, which is a routine for channels 95 to 99 that are never used in the ground wave TV broadcast.

The center frequency of channels 95 to 99 is distanced by more than a minimum 6 MHz from the center frequency of channels used for the ground wave TV broadcast.

First, channels are tuned in turn from 95 to 99. If a synchronization is detected even in one channel, a cable TV band is judged for the synchronization-detected channel and the judged cable TV band is determined to be the final cable TV band. And then, the cable TV band searching routine is terminated.

That is, after ‘CH_NO’ is set to be ‘95’ to search the cable TV band from the channel 95 (step S1000), a channel tuning is performed on the channel 95 (step S1002). When a synchronization is detected in the tuned channel 95 (step S1004), a cable TV band is judged for the channel 95 (step S1006).

If, however, no synchronization is detected in the tuned channel 95, the channel number ‘CH_NO’ is reduced ‘1’ by ‘1’ (step S1008) in order to repeatedly perform the channel tuning and synchronization detecting process up to the channel 99 until a synchronization is detected in the tuned channel (step S1010).

If the cable TV band judged in the step S1006 is STD band (step S1012), a cable TV band is finally determined to be STD band (step S1014). If the cable TV band judged in the step S1006 is not the STD band, a cable TV band is determined to be the HRC band (step S1016) and the entire cable TV band judging routine is terminated.

The channel tuning and synchronization detecting are repeatedly performed on the channels 95 to 99, and if a synchronization is detected in even one channel, a cable TV band searching process is performed on the synchronization-detected channel. If, however, no synchronization is detected in channels 95 to 99, the STD band, a default value, is determined to be the final cable TV band (step S1018) and then the cable TV band searching routine is terminated.

The reason for setting the STD band as a default value is because cable broadcast stations mostly use the STD band.

In the preferred embodiment of the present invention, when a cable TV band is judged even in one of channels 95 to 99, it is terminated, but a certain threshold value can be set and applied thereto.

In addition, as shown in FIG. 2, as for the channels 95 to 99, since the center frequencies of the STD band and the IRC band are the same with each other, the STD band and the IRC band are not discriminated, whereas the STD band (or the IRC band) and the HRC band can be discriminated.

Therefore, in the case that a cable TV band is judged to be the STD band in the routine ‘E’, if no synchronization is detected by using the STD band in the digital cable channels 5 and 6 when a channel map is constructed on the digital cable channels while scanning the digital cable channel with the STD band, a channel tuning must be performed even by using the IRC band.

The reason is that, practically, a cable TV band is judged to be the STD band in a cable TV band searching algorithm, and in such a case, a case where there is a digital cable signal as a center frequency of the IRC band in the channels 5 and 6 needs to be coped with.

In the preferred embodiment of the present invention, after a cable TV band is detected by using an analog cable TV signal, a cable TV band for a digital cable TV signal contained in the cable TV band is detected.

The reason is because, compared to use of the analog signal, much more time is taken for analyzing a PSIP (Program and System Information Protocol) and recognize major-minor channel information in order to store a searched channel in a channel map after detecting a synchronization by using the digital signal.

As so far described, the method for searching a cable TV band in accordance with the present invention has the following advantage.

That is, the cable TV band searching is performed by using a channel having a general VHF band frequency and then a cable TV band searching is performed on a channel having a frequency a ground wave TV signal does not use. Therefore, the cable TV band can be stably judged even in an environment with a much noise that a ground wave broadcast is must-carried to the cable channel.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for searching a cable TV band including an STD band, an HRC band and an IRC band, comprising the steps of:
a first step of detecting a cable TV band for a channel of a VHF frequency band; and
a second step of detecting a cable TV band for a channel of a frequency band a ground TV does not use in order to confirm whether the detected cable TV band is accurate.

2. The method of claim 1, wherein the first step comprises:
tuning from a channel 14 to a channel 11 of a VHF frequency band and detecting synchronization of a tuned channel;
judging a cable TV band of the synchronization-detected channel;
judging whether the synchronization-detected channel is an STD band and IRC band discriminated channel (the STD band and IRC band discriminated channel is a channel 5 or a channel 6);
increasing an IRC band counter value, an IRC band counter value and an HRC band counter value according to the judged cable TV band if the synchronization-detected channel is not the STD band and IRC band discriminated channel;
judging whether a cable band has been judged for the STD band and the IFC band discriminated channel if one of the band counter values is above a preset threshold value; and
performing a cable band judging for the STD band and IRC band discriminated channel if the cable band has not been judged yet for the STD band and IFC band discriminated channel.

3. The method of claim 2, wherein, in the step of increasing an IRC band counter value, an IRC band counter value and an HRC band counter value according to the judged cable TV band if the synchronization-detected channel is not the STD band and IRC band discriminated channel, if the judged cable TV band is STD (or IRC) band, an STD band counter value and an IRC band counter value are increased, whereas if the judged cable TV band is HRC band, an HRC band counter value is increased.

4. The method of claim 2, wherein in the case that the cable TV band judging is performed on the STD band an IRC band discriminated channel, if the HRC band counter value is above a pre-set threshold value and the STD band counter value is ‘0’, the cable TV band is finally determined as the HRC band, or if the HRC band counter value is below the pre-set threshold value or other band counter value is greater than ‘0’, the second step is performed.

5. The method of claim 1, if synchronization is detected in the STD band IRC band discriminated channel, further comprising:
increasing a STD band counter value if the judged cable TV band is STD band, increasing an IRC band counter value if the judged cable TV band is IRC band, and increasing an HRC band counter value if the judged cable TV band is HRC band; and
finally determining a cable TV band as the IRC band or as the HRC band if, among the increased band counter values, only the IRC band counter value is above ‘1’ or only the HRC band counter value is above ‘1’, or performing the second step if the STD band counter value is above ‘1’ or if the IRC band counter value and the HRC band counter value are all above ‘1’.

6. The method of claim 2, wherein if no synchronization is detected in the STD band and IRC band discriminated channel and each counter value is smaller than the threshold value or if the STD band counter value is ‘0’ and the HRC band counter value is above ‘1’ but smaller than the threshold value, the cable TV band is finally determined as the HRC band, and if the STD band counter value is above ‘1’ but smaller than the threshold value, if the HRC band counter value is ‘0’ or above ‘1’ but smaller than the threshold value, or if the STD band counter value and the HRC band counter value are all ‘0’, the second step is performed.

7. The method of claim 1, wherein the second step comprises:
detecting a synchronization while sequentially.tuning channels from 14 to 64;
judging a cable TV band for a synchronization-detected channel when a synchronization is detected in one of the channels; and
determining an STD band as a final cable TV band if the judged cable TV band is the STD band, or otherwise determining an HRC band as a final cable TV band if the judged cable TV band is the HRC band.

8. The method of claim 7 further comprising:
detecting a synchronization while sequentially tuning channels from 95 to 99 if no synchronization is detected in channels from 14 to 64;
judging a cable TV band of a synchronization-detected channel if synchronization is detected in one of the channels; and
determining an STD band as a final cable TV band if the judged cable TV band is the STD band, or otherwise determining an HRC band as a final cable TV band if the judged cable TV band is the HRC band.

9. The method of claim 8, wherein if no synchronization is detected in channels 95 to 99, a cable TV band is determined as the STD, a default value.
